(19) United States
(12) Patent Application Publication
(10) Pub. No.: US 2009/0324002 A1
(43) Pub. Date: Dec. 31, 2009

(54) Method and Apparatus with Display and Speaker

(75) Inventor: Nigel Richardson, Farnham (GB)

Correspondence Address: Nokia, Inc., 6021 Connection Drive, MS 2-5-520, Irving, TX, 75039, US

(73) Assignee: NOKIA CORPORATION, Espoo (FI)

(21) Appl. No.: 12/147,701

(22) Filed: Jun. 27, 2008

(51) Int. Cl. H04R 1/02

(52) U.S. Cl. 381/388

(57) ABSTRACT

In accordance with an example embodiment of the present invention, an apparatus, comprising a first housing comprising a display, a second housing comprising at least one speaker; the second housing being movably attached to the first housing, the first housing and said second housing being configured to provide a first operable position and a second operable position, and the at least one speaker being outward facing in said first operable position and said second operable position is disclosed.

### TECHNICAL FIELD

The present application relates generally to electronic devices.

### BACKGROUND

The modern era of electronic devices has seen a dramatic increase in the number of electronic devices used by individuals. These devices are experiencing an unprecedented growth in consumer demand.

### SUMMARY

Various aspects of the invention are set out in the claims.

In accordance with an example embodiment of the present invention, an apparatus, comprising a first housing comprising a display, a second housing comprising at least one speaker; the second housing being movably attached to the first housing, the first housing and said second housing being configured to provide a first operable position and a second operable position, and the at least one speaker being outward facing in said first operable position and said second operable position is disclosed.

### BRIEF DESCRIPTION OF THE DRAWINGS

For a more complete understanding of example embodiments of the present invention, reference is now made to the following descriptions taken in connection with the accompanying drawings in which:

FIGS. 1A, 1B, 1C, and 1D illustrate an apparatus according to an example embodiment of the present invention;

FIGS. 2A, 2B, 2C, and 2D illustrate an apparatus according to another example embodiment of the present invention;

FIGS. 3A, 3B, 3C, and 3D illustrate an apparatus according to yet another example embodiment of the present invention;

FIGS. 4A, 4B, 4C, 4D, and 4E illustrate an apparatus according to still another example embodiment of the present invention; and

FIG. 5 is a block diagram of an electronic device which may benefit from the present invention.

### DETAILED DESCRIPTION OF THE DRAWINGS

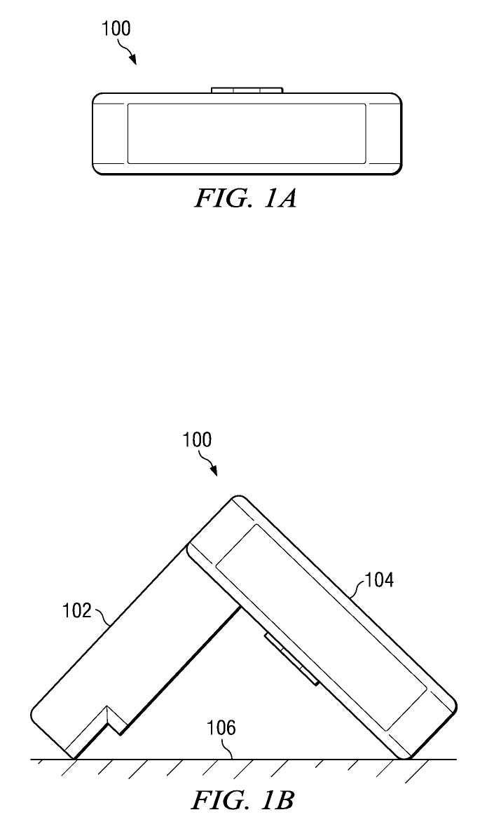

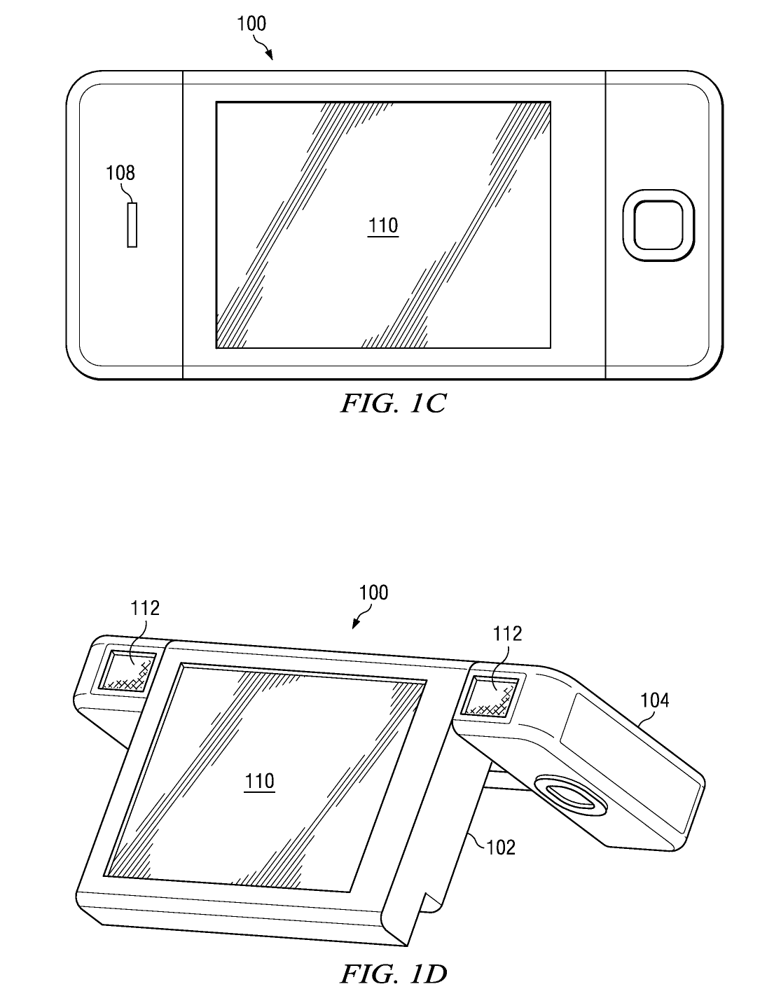

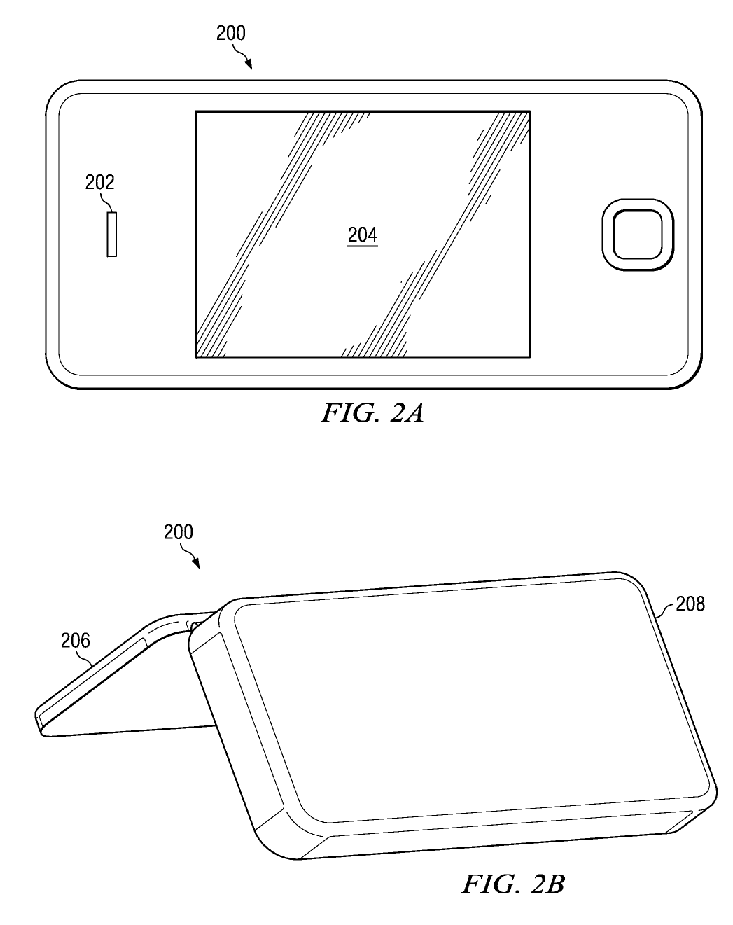

An example embodiment of the present invention and its potential advantages are best understood by referring to FIGS. 1A through 5 of the drawings.

It may be desirable to provide a configurable device to provide more than one speaker and display configuration. For example, a user may desire a speaker and display configuration when carrying a device. In the same example, the user may desire a different speaker and/or display configuration when resting the device on a surface. It may be desirable for a device to be configured to have a beneficial viewing and listening. For example, it the device is a media player, it may be desirable for the speaker to face about the same direction as the display faces. It may be desirable for an apparatus to be configurable to vary the alignment of the listening angle of at least one speaker with respect to a display. For example, if the apparatus is a mobile phone, it may be desirable for a loud speaker to be directed away from the user's ear when the phone is held close to the face.

FIGS. 1A, 1B, 1C, and 1D illustrate an apparatus 100 according to an example embodiment of the present invention. It should be understood, however, that the apparatus embodiment of FIGS. 1A, 1B, 1C, and 1D as illustrated and hereinafter described is merely illustrative of an apparatus which may comprise an embodiment of the present invention, and therefore, should not be taken to limit the scope of the present invention.

FIG. 1A illustrates apparatus 100 in a first operable position. Apparatus 100 may comprise an electronic device, a mobile device, a mobile terminal, a mobile phone, and/or the like. FIG. 1B illustrates apparatus 100 in a second operable position in relation to a resting base 106. The resting base may comprise a surface upon which apparatus 100 is located. For example, resting base 106 may be a table, a shelf, a desk, a floor, and/or the like. It should be understood that the resting base 106 merely refers to a surface upon which the apparatus rests, and should not be taken to limit the scope of the present invention. In an example embodiment, apparatus 100 may be mounted to a wall, a ceiling, and/or the like. In an example embodiment, apparatus 100 may comprise a first housing 102 and a second housing 104. In an example embodiment, the first housing 102 and the second housing 104 may be movably attached so that apparatus 100 may be configured in the first operable position or the second operable position. For example, the first housing 102 and the second housing 104 may be rotatably attached so that the first housing 102 rotates with respect to the second housing 104. In an example embodiment, the second operable position may be configured so that the first housing 102 may be inclined with respect to the resting base 106. For example, the angle between the first housing 102 and the resting base 106 may greater than about zero degrees and less than about 90 degrees. It can be seen in FIG. 1A and FIG. 1B that the angle of the first housing 102 and resting base 106 may vary between the first operative position and the second operative position.

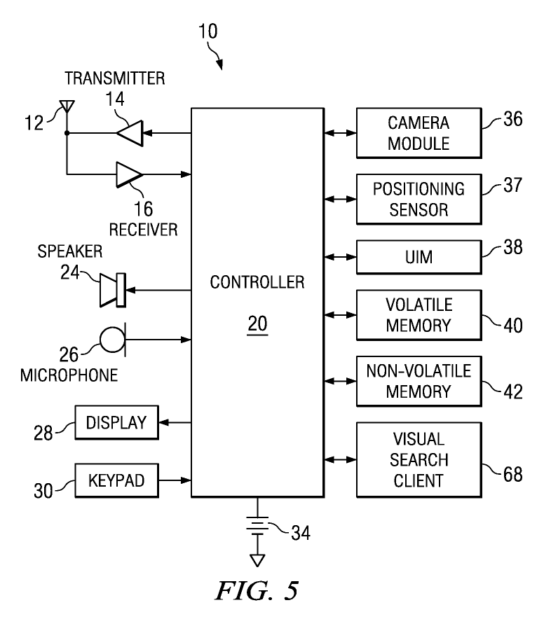

FIG. 1C illustrates apparatus 100 in the first operable position. In an example embodiment, apparatus 100 may comprise a display 110. The display 110 may comprise a screen which is configured to show information to a user, for example display 28 of FIG. 5. In an example embodiment, the display 110 may comprise a liquid crystal display, a plasma screen, and/or the like. The second housing 104 may comprise a speaker 108. Speaker 108 may be non-movably attached to the apparatus. When apparatus 100 is configured in the first operable position, it may be desirable for speaker 108 to face in substantially the same direction as display 110. For example, there may be a substantial overlap in the listening angle of speaker 108 and the viewing angle of display 110. In an example embodiment, if apparatus 100 is a mobile phone, it may be desirable for speaker 108 to face substantially the same direction as display 110. In an example embodiment, it may be desirable for the first housing 102 to comprise speaker 108. In an example embodiment, it may be desirable for apparatus 100 not to comprise speaker 108. For example, if apparatus 100 is a media player, it may be desirable for apparatus 100 not to comprise speaker 108.

FIG. 1D illustrates apparatus 100 in the second operable position. In an example embodiment, the second housing 104 may comprise at least one speaker 112. For example, the second housing 104 may comprise a single speaker 112. In another example, the second housing 104 may comprise multiple speakers 112. In such an example, the multiple speakers 112 may be configured for stereophonic operation, surround sound operation, and/or the like. In the example embodiment of FIG. 1D, it can be seen that speaker 112 and display 110 face in substantially the same direction. For example, at least part of the viewing angle of display 110 and at least part of the listening angle of speaker 112 may overlap. In an example embodiment, the second housing 104 is configured so that speaker 112 is outward facing when apparatus 100 is configured in the first operable position and when apparatus 100 is configured in the second operable position.

In embodiments where apparatus 100 comprises a speaker 108, it may be desirable for speaker 108 to have a lower maximum output level than the maximum output level of speaker 112. For example, if apparatus 100 is a mobile phone, speaker 108 may be configured to be placed close to an ear, for example as an earpiece. In such an example, speaker 112 may be configured to be placed further from the ear than speaker 108, for example more than one foot from of the user. In this example, it may be desirable for speaker 112 to have a maximum output level higher than the maximum output level of speaker 108. In such an example, it may be desirable to configure apparatus 100 so that speaker 112 and speaker 108 do not face substantially the same direction when apparatus 100 is configured in the first operable position. For example, if apparatus 100 is a mobile phone comprising speaker 108 and speaker 112, it may be desirable to configure apparatus 100 so that speaker 112 and speaker 108 do not face substantially the same direction when apparatus 100 is configured in the first operable position. In this example, when speaker 108 is placed close to an ear, this configuration may reduce the sound from speaker 112 entering the ear. It can be seen that in the example embodiment of FIG. 1D that the second housing is oriented so that speaker 108 does not face in substantially the same direction as the display 110 in the second operable position.

It may be desirable for apparatus 100 to comprise a keypad, for example keypad 30 of FIG. 5. For example, if apparatus 100 is a mobile terminal, it may be desirable for apparatus 100 to comprise a numeric keypad, an alphanumeric keypad, and/or the like. In an example embodiment, the first housing 102 and/or the second housing 104 may comprise the keypad.

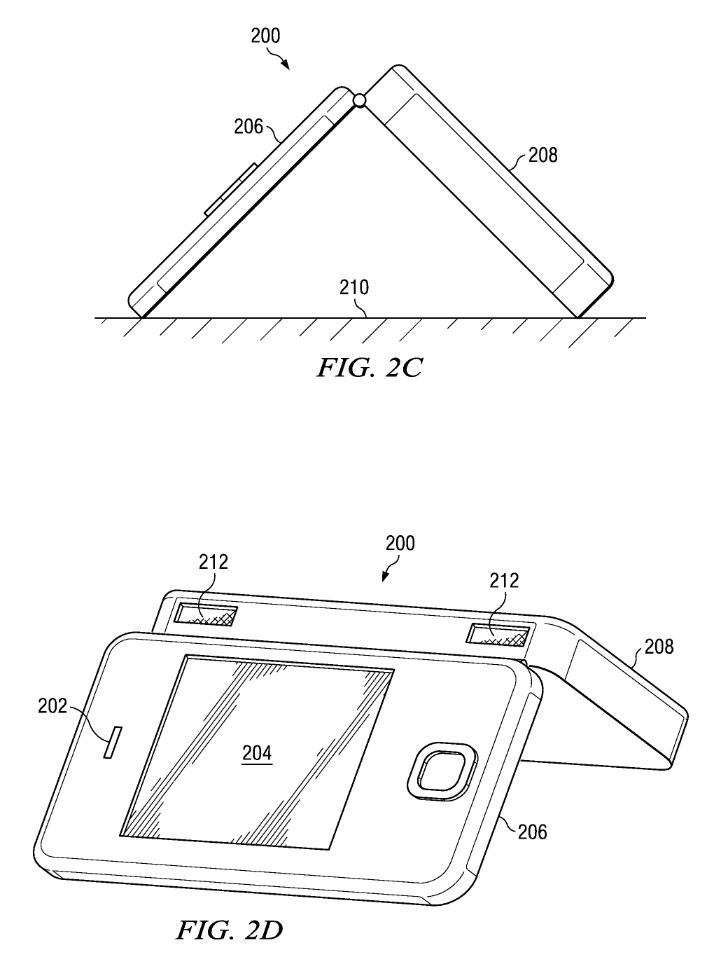

FIGS. 2A, 2B, 2C, and 2D illustrate an apparatus 200 according to another example embodiment of the present invention. It should be understood, however, that the apparatus embodiment of FIGS. 2A, 2B, 2C, and 2D as illustrated and hereinafter described is merely illustrative of an apparatus which may comprise an embodiment of the present invention, and therefore, should not be taken to limit the scope of the present invention.

FIG. 2A illustrates apparatus 200 in a first operable position. In an example embodiment, apparatus 200 may comprise a display 204. The display 204 may comprise a screen which is configured to show information to a user, for example display 28 of FIG. 5. In an example embodiment, the display 204 may comprise a liquid crystal display, a plasma screen, and/or the like. A first housing, for example first housing 206 of FIG. 2B, may comprise a speaker 202. Speaker 202 may be non-movably attached to the apparatus. When apparatus 200 is configured in the first operable position, it may be desirable for speaker 202 to face in substantially the same direction as display 204. For example, there may be a substantial overlap in the listening angle of speaker 202 and the viewing angle of display 204. In an example embodiment, if apparatus 200 is a mobile phone, it may be desirable for speaker 202 to face in substantially the same direction as display 204. In an example embodiment, it may be desirable for apparatus 200 not to comprise speaker 202. For example, if apparatus 200 is a media player, it may be desirable for apparatus 200 not to comprise speaker 202.

FIG. 2B illustrates apparatus 200 in a second operative position. In an example embodiment, apparatus 200 may comprise a first housing 206 and a second housing 208. FIG. 2C illustrates apparatus 200 in the second operable position in relation to a resting base 210. The resting base may comprise a surface upon which apparatus 200 is located. For example, resting base 210 may be a table, a shelf, a desk, a floor, and/or the like. It should be understood that the resting base merely refers to a surface upon which the apparatus rests, and should not be taken to limit the scope of the present invention. In an example embodiment, the first housing 206 and the second housing 208 may be movably attached so that apparatus 200 may be configured in the first operable position or the second operable position. For example, the first housing 206 and the second housing 208 may be rotatably attached so that the first housing 206 rotates with respect to the second housing 208. In an example embodiment, the second operable position may be configured so that the first housing 206 may be inclined with respect to the resting base 210. For example, the angle between the first housing 206 and the resting base 210 may greater than zero degrees and less than 90 degrees. It can be seen in FIG. 2A and FIG. 2B that the angle of the first housing 206 and resting base 210 may vary between the first operative position and the second operative position.

FIG. 2D illustrates apparatus 200 in the second operable position. In an example embodiment, the second housing 208 may comprise at least one speaker 212. For example, the second housing 208 may comprise a single monophonic speaker 212. In another example, the second housing 208 may comprise multiple speakers 212. In such an example, the multiple speakers 212 may be configured for stereophonic operation, surround sound operation, and/or the like. In the example embodiment of FIG. 2D, it can be seen that speaker 212 and display 204 face in substantially the same direction. For example, at least part of the viewing angle of display 204 and at least part of the listening angle of speaker 212 may overlap. In an example embodiment, the second housing 208 is configured so that speaker 212 is outward facing when apparatus 200 is configured in the first operable position and when apparatus 200 is configured in the second operable position.

In embodiments where apparatus 200 comprises a speaker 202, it may be desirable for speaker 202 to have a lower maximum output level than the maximum output level of the speaker 212. For example, if apparatus 200 is a mobile phone, speaker 202 may be configured to be placed close to an ear, for example as an earpiece. In such an example, speaker 212 may be configured to be placed further from the ear than speaker 202, for example more than one foot from of the user. In this example, it may be desirable for speaker 212 to have a maximum output level higher than the maximum output level of speaker 202. In such an example, it may be desirable to configure apparatus 200 so that speaker 212 and speaker 202 do not face in substantially the same direction when apparatus 200 is configured in the first operable position. For example, if apparatus 200 is a mobile phone comprising speaker 202 and speaker 212, it may be desirable to configure apparatus 200 so that speaker 212 and speaker 202 do not face in substantially the same direction when apparatus 200 is configured in the first operable position. In this example, when speaker 202 is placed close to an ear, this configuration may reduce the sound from speaker 212 entering the ear.

It may be desirable for apparatus 200 to comprise a keypad, for example keypad 30 of FIG. 5. For example, if apparatus 200 is a mobile terminal, it may be desirable for apparatus 200 to comprise a numeric keypad, an alphanumeric keypad, and/or the like. In an example embodiment, the first housing 206 and/or the second housing 208 may comprise the keypad.

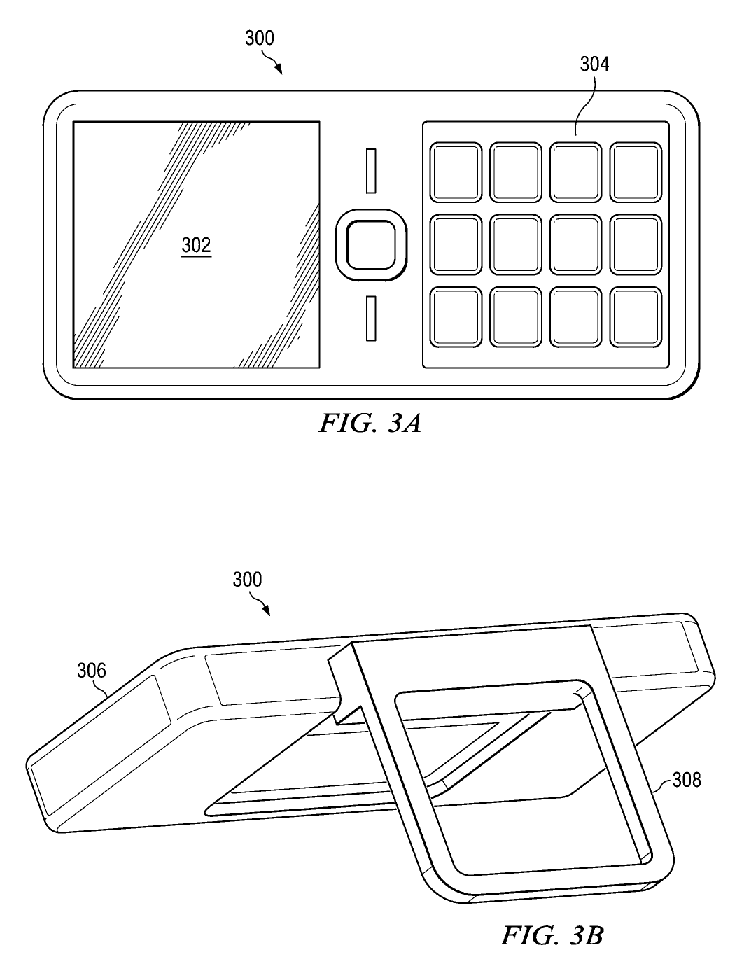

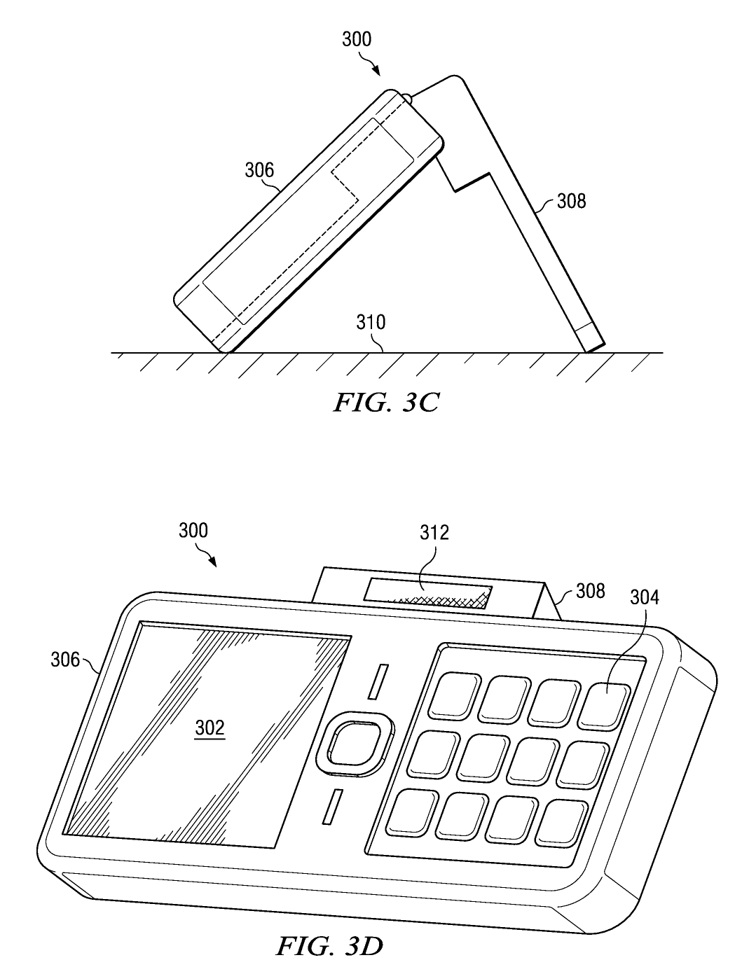

FIGS. 3A, 3B, 3C, and 3D illustrate an apparatus 300 according to yet another example embodiment of the present invention. It should be understood, however, that the apparatus embodiment of FIGS. 3A, 3B, 3C, and 3D as illustrated and hereinafter described is merely illustrative of an apparatus which may comprise an embodiment of the present invention, and therefore, should not be taken to limit the scope of the present invention.

FIG. 3A illustrates apparatus 300 in a first operable position. In an example embodiment, apparatus 300 may comprise a display 302. The display 302 may comprise a screen which is configured to show information to a user, for example display 28 of FIG. 5. In an example embodiment, the display may comprise a liquid crystal display, a plasma screen, and/or the like. A first housing, for example first housing 306 of FIG. 3B, may comprise a keypad 304 for example keypad 30 of FIG. 5. Keypad 304 may comprise a numeric keypad, an alphanumeric keypad, and/or the like.

FIG. 3B illustrates apparatus 300 in a second operative position. In an example embodiment, apparatus 300 may comprise a first housing 306 and a second housing 308. FIG. 3C illustrates apparatus 300 in the second operable position in relation to a resting base 310. The resting base may comprise a surface upon which apparatus 300 is located. For example, resting base 310 may be a table, a shelf, a desk, a floor, and/or the like. It should be understood that the resting base merely refers to a surface upon which the apparatus rests, and should not be taken to limit the scope of the present invention. In an example embodiment, the first housing 306 and the second housing 308 may be movably attached so that apparatus 300 may be configured in the first operable position or the second operable position. For example, the first housing 306 and the second housing 308 may be rotatably attached so that the first housing 306 rotates with respect to the second housing 308. In an example embodiment, the second operable position may be configured so that the first housing 306 may be inclined with respect to the resting base 310. For example, the angle between the first housing 306 and the resting base 310 may greater than zero degrees and less than 90 degrees. It can be seen in FIG. 3A and FIG. 3B that the angle of the first housing 306 and resting base 310 may vary between the first operative position and the second operative position.

FIG. 3D illustrates apparatus 300 in the second operable position. In an example embodiment, the second housing 308 may comprise at least one speaker 312. For example, the second housing 308 may comprise a single monophonic speaker 312. In another example, the second housing 308 may comprise multiple speakers 312. In such an example, the multiple speakers 312 may be configured for stereophonic operation, surround sound operation, and/or the like. In the example embodiment of FIG. 3D, it can be seen that speaker 312 and display 302 face in substantially the same direction. For example, at least part of the viewing angle of display 302 and at least part of the listening angle of speaker 312 may overlap. In an example embodiment, the second housing 308 is configured so that speaker 312 is outward facing when apparatus 300 is configured in the first operable position and when apparatus 300 is configured in the second operable position.

In an example embodiment, it may be desirable for first housing 306 to comprise a speaker. When apparatus 300 is configured in the first operable position, it may be desirable for speaker of the first housing 306 to face in substantially the same direction as display 302. For example, there may be a substantial overlap in the listening angle of the speaker of the first housing 306 and the viewing angle of display 302. In an example embodiment, if apparatus 300 is a mobile phone, it may be desirable for the speaker of the first housing 306 to face in substantially the same direction as display 302.

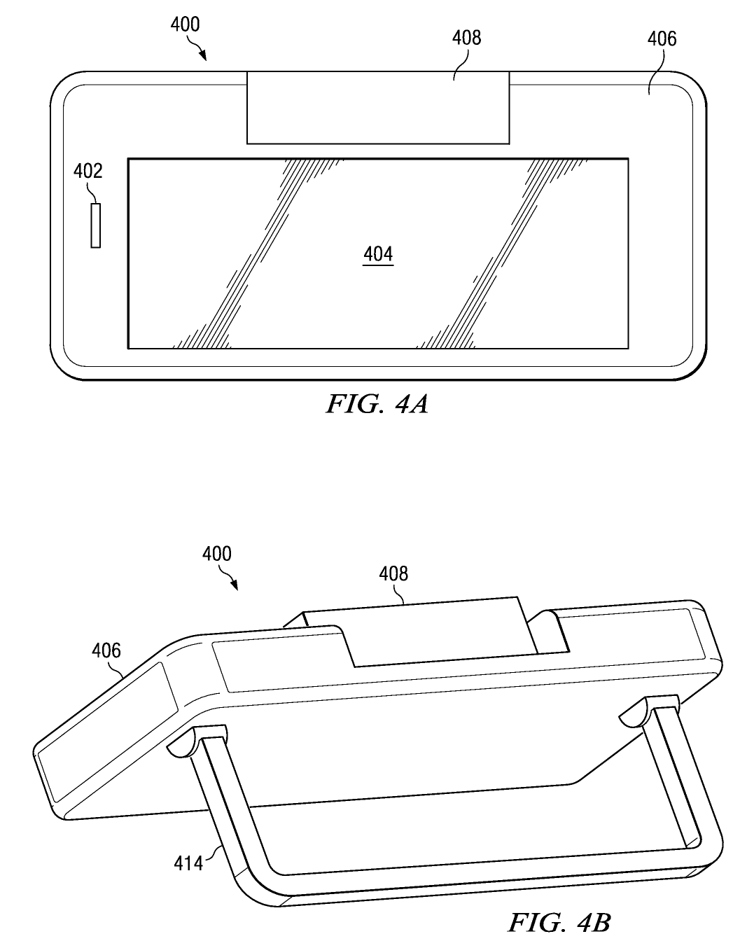

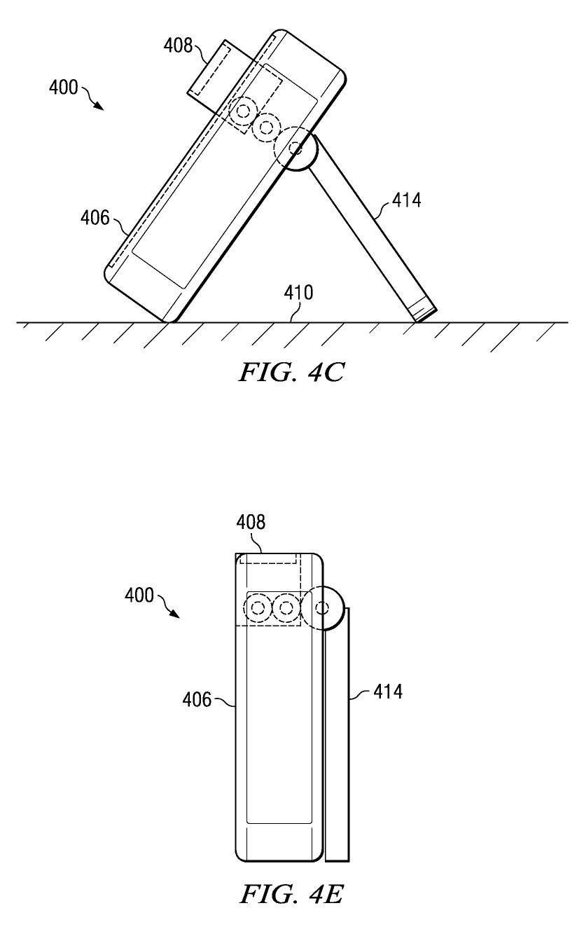

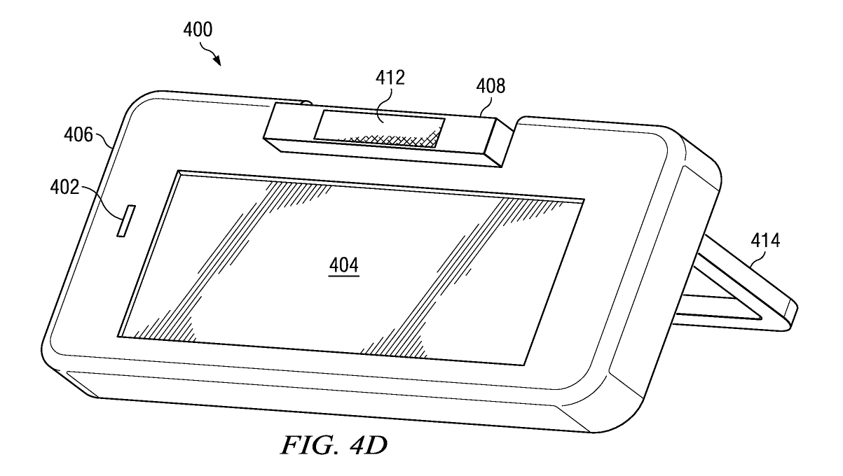

FIGS. 4A, 4B, 4C, 4D, and 4E illustrate an apparatus 400 according to still another example embodiment of the present invention. It should be understood, however, that the apparatus embodiment of FIGS. 4A, 4B, 4C, 4D, and 4E as illustrated and hereinafter described is merely illustrative of an apparatus which may comprise an embodiment of the present invention, and therefore, should not be taken to limit the scope of the present invention.

FIG. 4A illustrates apparatus 400 in a first operable position. In an example embodiment, apparatus 400 may comprise a first housing 406 and a second housing 408. In an example embodiment, first housing 406 may comprise a display 404. The display 404 may comprise a screen which is configured to show information to a user, for example display 28 of FIG. 5. In an example embodiment, the display may comprise a liquid crystal display, a plasma screen, and/or the like. The first housing 406 may comprise a speaker 402. Speaker 402 may be non-movably attached to the apparatus. When apparatus 400 is configured in the first operable position, it may be desirable for speaker 402 to face in substantially the same direction as display 404. For example, there may be a substantial overlap in the listening angle of speaker 402 and the viewing angle of display 404. In an example embodiment, if apparatus 400 is a mobile phone, it may be desirable for speaker 402 to face in substantially the same direction as display 404. In an example embodiment, it may be desirable for apparatus 400 not to comprise speaker 402. For example, if apparatus 400 is a media player, it may be desirable for apparatus 400 not to comprise speaker 402.

FIG. 4B illustrates apparatus 400 in a second operative position. In an example embodiment, apparatus 400 may comprise the first housing 406, the second housing 408, and a third housing 414.

FIG. 4C illustrates apparatus 400 in the second operable position in relation to a resting base 410. The resting base may comprise a surface upon which apparatus 400 is located. For example, resting base 410 may be a table, a shelf, a desk, a floor, and/or the like. It should be understood that the resting base merely refers to a surface upon which the apparatus rests, and should not be taken to limit the scope of the present invention. In an example embodiment, the first housing 406, the second housing 408, and the third housing 414 may be movably attached so that apparatus 400 may be configured in the first operable position or the second operable position. For example, the first housing 406 and the second housing 408 may be rotatably attached so that the first housing 406 rotates with respect to the second housing 408. In another example, the first housing 406 and the third housing 414 may be rotatably attached so that the first housing 406 rotates with respect to the third housing 414. In an example embodiment, the orientation of the third housing 414 may be coupled to the orientation of the second housing 408 so that movement of the third housing 414 may result in movement of the second housing 408. For example, there may be a gear, belt, motor, sensor, and/or the like which relates motion of the third housing 414 to motion of the second housing 408. In an example embodiment, the second operable position may be configured so that the first housing 406 may be inclined with respect to the resting base 410. For example, the angle between the first housing 406 and the resting base 410 may greater than zero degrees and less than 90 degrees. It can be seen in FIG. 4A, FIG. 4B, and FIG. 4C that the angle of the first housing 406 and resting base 410 may vary between the first operative position and the second operative position.

FIG. 4D illustrates apparatus 400 in the second operable position. In an example embodiment, the second housing 408 may comprise at least one speaker 412. For example, the second housing 408 may comprise a single monophonic speaker 412. In another example, the second housing 408 may comprise multiple speakers 412. In such an example, the multiple speakers 412 may be configured for stereophonic operation, surround sound operation, and/or the like. In the example embodiment of FIG. 4D, it can be seen that speaker 412 and display 404 face in substantially the same direction. For example, at least part of the viewing angle of display 404 and at least part of the listening angle of speaker 412 may overlap. In an example embodiment, the second housing 408 is configured so that speaker 412 is outward facing when apparatus 400 is configured in the first operable position and when apparatus 400 is configured in the second operable position.

In embodiments where apparatus 400 comprises a speaker 402, it may be desirable for speaker 402 to have a lower maximum output level than the maximum output level of the speaker 412. For example, if apparatus 400 is a mobile phone, speaker 402 may be configured to be placed close to an ear, for example as an earpiece. In such an example, speaker 412 may be configured to be placed further from the ear than speaker 402, for example more than one foot from of the user. In this example, it may be desirable for speaker 412 to have a maximum output level higher than the maximum output level of speaker 402. In such an example, it may be desirable to configure apparatus 400 so that speaker 412 and speaker 402 do not face in substantially the same direction when apparatus 400 is configured in the first operable position. For example, if apparatus 400 is a mobile phone comprising speaker 402 and speaker 412, it may be desirable to configure apparatus 400 so that speaker 412 and speaker 402 do not face in substantially the same direction when apparatus 400 is configured in the first operable position. In this example, when speaker 402 is placed close to an ear, this configuration may reduce the sound from speaker 412 entering the ear.

FIG. 4E illustrates another view of apparatus 400 in the first operable position.

It may be desirable for apparatus 400 to comprise a keypad, for example keypad 30 of FIG. 5. For example, if apparatus 400 is a mobile terminal, it may be desirable for apparatus 400 to comprise a numeric keypad, an alphanumeric keypad, and/or the like. In an example embodiment, the first housing 406, the second housing 208, and/or the third housing 414 may comprise the keypad.

In an example embodiment, it may be desirable for an apparatus to perform an action when the apparatus is moved from a first operable position to a second operable position and/or when the apparatus is moved form the second operable position to the first operable position. Such action may comprise a controller, for example controller 2 of FIG. 5, executing operations. Such controller operations may relate to software functions.

In an example embodiment, it may be desirable for a software event to be triggered upon a transition between the first operable position and the second operable position. In an example embodiment, when an apparatus is moved into the second operable position, media player software may be invoked. In another example embodiment, when an apparatus in moved into the second operable position, the media player software may perform an operation, such as playing media. In another example embodiment, when an apparatus is moved into the first operable position, mobile phone software may be invoked. In another example embodiment, display orientation may be modified when the apparatus is moved between the first operable position and the second operable position. For example, when the apparatus is moved to the first operable position, the display may be oriented in a portrait mode. In another example, when the apparatus is moved to the second operable position, the display may be oriented in a landscape mode.

FIG. 5 is a block diagram of an electronic device, for example, electronic device 10, which may benefit from the present invention. It should be understood, however, that a electronic device as illustrated and hereinafter described is merely illustrative of an electronic device that would benefit from embodiments of the present invention and, therefore, should not be taken to limit the scope of the present invention. While one embodiment of the electronic device 10 is illustrated and will be hereinafter described for purposes of example, other types of electronic devices, such as, but not limited to, portable digital assistants (PDAs), pagers, mobile computers, desktop computers, televisions, gaming devices, laptop computers, cameras, video recorders, GPS devices and other types of electronic systems, may readily employ embodiments of the present invention. Furthermore, devices may readily employ embodiments of the present invention regardless of their intent to provide mobility.

Embodiments of the present invention will be primarily described below in conjunction with mobile communications applications. However, it should be understood that embodiments of the present invention may be utilized in conjunction with a variety of other applications, both in the mobile communications industries and outside of the mobile communications industries.

The electronic device 10 comprises an antenna 12 (or multiple antennae) in operable communication with a transmitter 14 and a receiver 16. The electronic device 10 further comprises a controller 20 or other processing element that provides signals to and receives signals from the transmitter 14 and receiver 16, respectively. The signals may comprise signaling information in accordance with a communications interface standard, user speech, received data, user generated data, and/or the like. The electronic device 10 may operate with one or more air interface standards, communication protocols, modulation types, and access types. By way of illustration, the electronic device 10 may operate in accordance with any of a number of first, second, third and/or fourth-generation communication protocols or the like. For example, the electronic device 10 may operate in accordance with second-generation (2G) wireless communication protocols IS-136 (TDMA), GSM, and IS-95 (CDMA), or with third-generation (3G) wireless communication protocols, such as UMTS, CDMA2000, WCDMA and TD-SCDMA, with fourth-generation (4G) wireless communication protocols, wireless networking protocols, such as 802.11, short range wireless protocols, such as Bluetooth, and/or the like.

It is understood that the controller 20 comprises circuitry desirable for implementing audio and logic functions of the electronic device 10. For example, the controller 20 may comprise a digital signal processor device, a microprocessor device, various analog to digital converters, digital to analog converters, and other support circuits. Control and signal processing functions of the electronic device 10 are allocated between these devices according to their respective capabilities. The controller 20 thus may also comprise the functionality to convolutionally encode and interleave message and data prior to modulation and transmission. The controller 20 may additionally comprise an internal voice coder, and may comprise an internal data modem. Further, the controller 20 may comprise functionality to operate one or more software programs, which may be stored in memory. For example, the controller 20 may operate a connectivity program, such as a conventional Web browser. The connectivity program may then allow the electronic device 10 to transmit and receive Web content, such as location-based content and/or other web page content, according to a Wireless Application Protocol (WAP), Hypertext Transfer Protocol (HTTP), and/or the like, for example.

The electronic device 10 may also comprise a user interface including an output device such as a ringer, a conventional earphone and/or speaker 24, a microphone 26, a display 28, and/or a user input interface, which are coupled to the controller 20. The user input interface, which allows the electronic device 10 to receive data, may comprise any of a number of devices allowing the electronic device 10 to receive data, such as a keypad 30, a touch display (not shown) or other input device. In embodiments including the keypad 30, the keypad 30 may comprise numeric (for example, 0-9) keys, symbol keys (for example, #, *), alphabetic keys, and/or the like for operating the electronic device 10. For example, the keypad 30 may comprise a conventional QWERTY keypad arrangement. The keypad 30 may also comprise various soft keys with associated functions. In addition, or alternatively, the electronic device 10 may comprise an interface device such as a joystick or other user input interface. The electronic device 10 further comprises a battery 34, such as a vibrating battery pack, for powering various circuits that are required to operate the electronic device 10, as well as optionally providing mechanical vibration as a detectable output.

In an example embodiment, the electronic device 10 comprises a media capturing element, such as a camera, video and/or audio module, in communication with the controller 20. The media capturing element may be any means for capturing an image, video and/or audio for storage, display or transmission. For example, in an example embodiment in which the media capturing element is a camera module 36, the camera module 36 may comprise a digital camera which may form a digital image file from a captured image. As such, the camera module 36 comprises hardware, such as a lens or other optical component(s), and/or software necessary for creating a digital image file from a captured image. Alternatively, the camera module 36 may comprise only the hardware for viewing an image, while a memory device of the electronic device 10 stores instructions for execution by the controller 20 in the form of software for creating a digital image file from a captured image. In an example embodiment, the camera module 36 may further comprise a processing element such as a co-processor which assists the controller 20 in processing image data and an encoder and/or decoder for compressing and/or decompressing image data. The encoder and/or decoder may encode and/or decode according to a standard format, for example, a JPEG standard format.

The electronic device 10 may further comprise a user identity module (UIM) 38. The UIM 38 may be a memory device having a built in processor. The UIM 38 may comprise, for example, a subscriber identity module (SIM), a universal integrated circuit card (UICC), a universal subscriber identity module (USIM), a removable user identity module (R-UIM), and/or the like. The UIM 38 may store information elements related to a mobile subscriber. In addition to the UIM 38, the electronic device 10 may be equipped with memory. For example, the electronic device 10 may comprise volatile memory 40, such as volatile Random Access Memory (RAM) including a cache area for the temporary storage of data. The electronic device 10 may also comprise other memory, for example, non-volatile memory 42, which may be embedded and/or may be removable. The non-volatile memory 42 may additionally or alternatively comprise an EEPROM, flash memory or the like, such as that available from the SanDisk Corporation of Sunnyvale, Calif., or Lexar Media Inc. of Fremont, Calif. The memories may store any of a number of pieces of information, and data. The information and data may be used by the electronic device 10 to implement the functions of the electronic device 10. For example, the memories may comprise an identifier, such as an international mobile equipment identification (IMEI) code, which may uniquely identify the electronic device 10.

Although FIG. 5 illustrates an example of a electronic device which may utilize embodiments of the present invention, it should be understood that the electronic device 10 of FIG. 5 is merely an example device that may utilize embodiments of the present invention. For example a device having a processing element for managing memory operations may utilize embodiments of the present invention. For example, such a device may also comprise or otherwise be in communication with a memory device. Such a device may comprise some form of user interface. For example, such devices could be, but are not limited to, portable digital assistants (PDAs), pagers, mobile computers, desktop computers, televisions, gaming devices, laptop computers, cameras, video recorders, GPS devices and other types of electronic systems. A processing element such as those described above may be embodied in various ways. For example, the processing element may be embodied as a processor, a coprocessor, a controller or various other processing means or devices including integrated circuits such as, for example, an ASIC (application specific integrated circuit), FPGA (field programmable gate array), and/or the like.

Without in any way limiting the scope, interpretation, or application of the claims appearing below, it is possible that a technical effect of one or more of the example embodiments disclosed herein may be to provide more than one speaker and display configuration. Another possible technical effect of one or more of the example embodiments disclosed herein may be to provide a beneficial viewing and listening angle for an apparatus. Another technical effect of one or more of the example embodiments disclosed herein may be to provide an apparatus which may be configured to vary the alignment of the listening angle of at least one speaker with respect to a display.

If desired, the different functions discussed herein may be performed in any order and/or concurrently with each other. Furthermore, if desired, one or more of the above-described functions may be optional or may be combined.

Although various aspects of the invention are set out in the independent claims, other aspects of the invention comprise any combination of features from the described embodiments and/or the dependent claims with the features of the independent claims, and not solely the combinations explicitly set out in the claims.

It is also noted herein that while the above describes example embodiments of the invention, these descriptions should not be viewed in a limiting sense. Rather, there are several variations and modifications which may be made without departing from the scope of the present invention as defined in the appended claims.

What is claimed is:

1. An apparatus, comprising:
a first housing comprising a display;
a second housing comprising at least one speaker;
said second housing being movably attached to said first housing;
said first housing and said second housing being configured to provide a first operable position and a second operable position; and
said at least one speaker being outward facing in said first operable position and said second operable position.

2. The apparatus of claim 1, wherein the angle between said second housing and a resting base varies between said first operable position and said second operable position.

3. The apparatus of claim 1, wherein said speaker is non-movably attached to said second housing.

4. The apparatus of claim 1, wherein said first housing comprises at least one speaker.

5. The apparatus of claim 4, wherein said second operable position is characterized by the listening angle of said at least one speaker of said first housing overlapping with the viewing angle of said display.

6. The apparatus of claim 4, wherein said at least one speaker of said first housing has a maximum output level lower than said at least one speaker of said second housing.

7. The apparatus of claim 1, wherein said at least one speaker of said second housing comprises a first speaker and a second speaker.

8. The apparatus of claim 7, wherein said first speaker faces in substantially the same direction as said display in said first operable position.

9. The apparatus of claim 7, wherein said first speaker faces a different direction than said display in said second operable position.

10. The apparatus of claim 7, wherein said first speaker has a maximum output level lower than said maximum output level of second speaker.

11. The apparatus of claim 1, wherein said at least one speaker faces substantially the same direction as the display in said second operable position.

12. The apparatus of claim 1, wherein said first housing is rotatably attached to said second housing.

13. The apparatus of claim 1, wherein said second operable position is configured such that an angle between said first housing and a resting base is greater than zero degrees and less than ninety degrees.

14. The apparatus of claim 1, wherein movement to said second operative position is configured to invoke a computer operation.

15. The apparatus of claim 14, wherein said computer operation is configured to modify display orientation.

16. The apparatus of claim 14, wherein said computer operation relates to a media player.

17. The apparatus of claim 1, wherein said apparatus is a mobile device.

18. The apparatus of claim 1, wherein said apparatus is a mobile phone.

19. The apparatus of claim 1, wherein said first housing comprises a keypad.

20. The apparatus of claim 1, wherein said second housing comprises a keypad.

21. The apparatus of claim 1, further comprising a third housing.

22. The apparatus of claim 21, wherein orientation of said second housing is coupled to orientation of said third housing.
